(19) United States
(12) Patent Application Publication
(10) Pub. No.: US 2025/0258751 A1
(43) Pub. Date: Aug. 14, 2025

(54) METHOD FOR PERFORMANCE SUPERVISION, APPARATUS, AND SYSTEM, DEVICE AND MEDIUM

(71) Applicant: SUZHOU METABRAIN INTELLIGENT TECHNOLOGY CO., LTD., Suzhou, Jiangsu (CN)

(72) Inventors: Chaofan CHEN, Jiangsu (CN); Fengming ZHAO, Jiangsu (CN); Jinming LIU, Jiangsu (CN)

(73) Assignee: SUZHOU METABRAIN INTELLIGENT TECHNOLOGY CO., LTD., Suzhou, Jiangsu (CN)

(21) Appl. No.: 18/857,724

(22) PCT Filed: May 23, 2023
(86) PCT No.: PCT/CN2023/095878

§ 371 Date: Oct. 17, 2024

(30) Foreign Application Priority Data
Nov. 25, 2022 (CN) 202211487121.4

(51) Int. Cl. G06F 11/34

(52) U.S. Cl. CPC G06F 11/3466

(57) ABSTRACT

The present disclosure relates to the technical field of servers. Disclosed are a method for performance supervision, apparatus and system, a device and a medium. The method includes: receiving a task to be processed which is transmitted by a baseboard management controller; converting, according to a set data conversion rule, data carried by the task to be processed into waveform data identifiable by a central processing unit; transmitting the waveform data to the central processing unit; receiving response data fed back by a target central processing unit; and converting the response data into effective data which meets a data transmission format requirement, and feeding the effective data back to the baseboard management controller.

### CROSS-REFERENCE TO RELATED APPLICATION

The present application is a National Stage Application of PCT International Application No.: PCT/CN2023/095878 filed on May 23, 2023, which claims priority to Chinese Patent Application 202211487121.4, filed in the China National Intellectual Property Administration on Nov. 25, 2022, the disclosure of which is incorporated herein by reference in its entirety.

### TECHNICAL FIELD

The present disclosure relates to the technical field of servers, and in particular, to a method for performance supervision, apparatus, and system, a device, and a non-transitory computer-readable storage medium.

### BACKGROUND

In related art, with the rapid development of the technical fields such as cloud services, Artificial Intelligence (AI), big data, and high-performance computation, higher requirements have been put forward for the performance and control capabilities of server systems. Particularly, the heat dissipation and fault diagnosis functions of servers have become important aspects that affect the performance and operation management of the servers.

To maintain the optimal running state of a cooling system, it is necessary to monitor the temperature of a Central Processing Unit/Processor (CPU) in real time during running of a server, to adjust a cooling strategy of the cooling system and ensure that the system runs normally within a preset temperature range. In addition, during the running of the server, when there is a serious unrecoverable error occurring in the CPU, such as an IERR error caused by CATERR, the server will crash. To locate and analyze the cause of a system failure after the crash through a fault diagnosis technology, it is necessary to “quickly acquire” key register information in the CPU before the crash.

It can be seen that how to improve the server monitoring efficiency is a problem that needs to be solved by a skilled person in the art.

### SUMMARY

According to a first aspect, the embodiments of the present disclosure provide a method for performance supervision, including:
receiving a task to be processed which is transmitted by a baseboard management controller;
converting, according to a set data conversion rule, data carried by the task to be processed into waveform data identifiable by a central processing unit;
transmitting the waveform data to the central processing unit;
receiving response data fed back by a target central processing unit, wherein the target central processing unit is a central processing unit matched with address information carried in the task to be processed; and
converting the response data into effective data which meets a data transmission format requirement, and feeding the effective data back to the baseboard management controller.

In some embodiments of the present disclosure, the converting, according to a set data conversion rule, data carried by the task to be processed into waveform data identifiable by a central processing unit includes:
extracting a command type, a command parameter, and the address information from the task to be processed according to a set data format;
converting, according to a set address conversion rule, the address information into real address information identifiable by the central processing unit; and
converting the command type, the command parameter, and the real address information into the waveform data.

In some embodiments of the present disclosure, the converting, according to a set address conversion rule, the address information into real address information identifiable by the central processing unit includes:
inquiring the real address information matched with the address information from a set address conversion list, wherein various pieces of I2C protocol address information and address information which respectively corresponds to the I2C protocol address information and is identifiable by the central processing unit are recorded in the address conversion list.

In some embodiments of the present disclosure, the converting the command type, the command parameter, and the real address information into the waveform data includes:
inquiring a target command waveform matched with the command type from pre-stored command waveforms;
converting the command parameter and the real address information into information waveforms; and
combining the target command waveform and the information waveforms into the waveform data.

In some embodiments of the present disclosure, the converting the response data into effective data which meets a data transmission format requirement includes:
analyzing the response data according to a data transmission format corresponding to the central processing unit to obtain check information and initial effective data;
checking the response data by using the check information; and
in response to that the checking performed on the response data succeeds, and a read request transmitted by the baseboard management controller is received, converting the initial effective data into effective data matched with a data format corresponding to the read request.

In some embodiments of the present disclosure, the converting the initial effective data into effective data matched with a data format corresponding to the read request includes:
setting a read-write operation identifier bit in a character string corresponding to the read request to a read identifier; and
filling free fields, adjacent to the read identifier, in the character string with the initial effective data in sequence to obtain the effective data.

In some embodiments of the present disclosure, in response to that the task to be processed is a connection task, the converting the response data into effective data which meets a data transmission format requirement, and feeding the effective data back to the baseboard management controller includes:
in response to that the response data is response information indicating that connection is successful, setting a connection identification bit in a character string corresponding to the connection task to a successful connection identifier; and
feeding the character string with the successful connection identifier as the effective data back to the baseboard management controller.

In some embodiments of the present disclosure, in response to that the task to be processed is to read temperature information of the target central processing unit, correspondingly, the response data includes the temperature information of the target central processing unit; and in response to that the task to be processed is to read information of a target register in the target central processing unit, correspondingly, the response data includes the register information of the target register.

According to a second aspect, the embodiments of the present disclosure further provide an apparatus for performance supervision, applicable to a complex programmable logic device. The apparatus includes a first receiving unit, a first conversion unit, a transmission unit, a second receiving unit, a second conversion unit, and a feedback unit;
the first receiving unit is configured to receive a task to be processed which is transmitted by a baseboard management controller;
the first conversion unit is configured to convert, according to a set data conversion rule, data carried by the task to be processed into waveform data identifiable by a central processing unit;
the transmission unit is configured to transmit the waveform data to the central processing unit;
the second receiving unit is configured to receive response data fed back by a target central processing unit, wherein the target central processing unit is a central processing unit matched with address information carried in the task to be processed;
the second conversion unit is configured to convert the response data into effective data which meets a data transmission format requirement; and
the feedback unit is configured to feed the effective data back to the baseboard management controller.

In some embodiments of the present disclosure, the first conversion unit includes an extraction subunit, an address conversion subunit, and a waveform conversion subunit;
the extraction subunit is configured to extract a command type, a command parameter, and the address information from the task to be processed according to a set data format;
the address conversion subunit is configured to convert, according to a set address conversion rule, the address information into real address information identifiable by the central processing unit; and
the waveform conversion subunit is configured to convert the command type, the command parameter, and the real address information into the waveform data.

In some embodiments of the present disclosure, the address conversion subunit is configured to inquire the real address information matched with the address information from a set address conversion list, wherein various pieces of I2C protocol address information and address information which respectively corresponds to the I2C protocol address information and is identifiable by the central processing unit are recorded in the address conversion list.

In some embodiments of the present disclosure, the waveform conversion subunit is configured to: inquire a target command waveform matched with the command type from pre-stored command waveforms; convert the command parameter and the real address information into information waveforms; and combine the target command waveform and the information waveforms into the waveform data.

In some embodiments of the present disclosure, the second conversion unit includes an analysis subunit, a check subunit, and a format conversion subunit;
the analysis subunit is configured to analyze the response data according to a data transmission format corresponding to the central processing unit to obtain check information and initial effective data;
the checking subunit is configured to check the response data by using the check information; and
the format conversion subunit is configured to: in response to that the checking performed on the response data succeeds, and a read request transmitted by the baseboard management controller is received, convert the initial effective data into effective data matched with a data format corresponding to the read request.

In some embodiments of the present disclosure, the format conversion subunit is configured to: set a read-write operation identifier bit in a character string corresponding to the read request to a read identifier; and fill in free fields, adjacent to the read identifier, in the character string with the initial effective data in sequence to obtain the effective data.

In some embodiments of the present disclosure, in response to that the task to be processed is a connection task, the second conversion unit is configured to: in response to that the response data is response information indicating that connection is successful, set a connection identification bit in a character string corresponding to the connection task to a successful connection identifier; and
the feedback unit is configured to feed the character string with the successful connection identifier as the effective data back to the baseboard management controller.

In some embodiments of the present disclosure, in response to that the task to be processed is to read temperature information of the target central processing unit, correspondingly, the response data includes the temperature information of the target central processing unit; and in response to that the task to be processed is to read information of a target register in the target central processing unit, correspondingly, the response data includes the register information of the target register.

According to a third aspect, the embodiments of the present disclosure further provide a method for performance supervision, applicable to a baseboard management controller. The method includes:
transmitting a task to be processed to a complex programmable logic device;
receiving effective data fed back by the complex programmable logic device, wherein the effective data is effective data that is converted, after data carried by the task to be processed is converted into waveform data identifiable by a central processing unit according to a set data conversion rule by the complex programmable logic device, from response data fed back by the central processing unit and meets a data transmission format requirement; and
extracting desired data from the effective data.

In some embodiments of the present disclosure, the transmitting a task to be processed to a complex programmable logic device includes:
converting a control command to be sent into a command code; and
converting the command code, address information, and a command parameter into the task to be processed according to a data format corresponding to the command code.

According to a fourth aspect, the embodiments of the present disclosure further provide an apparatus for performance supervision, applicable to a baseboard management controller. The apparatus includes a transmission unit, a receiving unit, and an extraction unit;
the transmission unit is configured to transmit a task to be processed to a complex programmable logic device;
the receiving unit is configured to receive effective data fed back by the complex programmable logic device, wherein the effective data is effective data that is converted, after data carried by the task to be processed is converted into waveform data identifiable by a central processing unit according to a set data conversion rule by the complex programmable logic device, from response data fed back by the central processing unit and meets a data transmission format requirement; and
the extraction unit is configured to extract desired data from the effective data.

According to a fifth aspect, the embodiments of the present disclosure further provide a method for performance supervision, applicable to a central processing unit. The method includes: in response to that waveform data transmitted by a complex programmable logic device is
received, analyzing the waveform data to obtain real address information and task information, wherein the waveform data is waveform data that is converted, from data carried by a received task to be processed which is transmitted by a baseboard management controller, by the complex programmable logic device according to a set data conversion rule and is identifiable by the central processing unit; and
in response to that the real address information is matched with an own address, feeding response data corresponding to the task information back to the complex programmable logic device.

According to a sixth aspect, the embodiments of the present disclosure further provide an apparatus for performance supervision, applicable to a central processing unit. The apparatus includes an analysis unit and a feedback unit;
the analysis unit is configured to: in response to that waveform data transmitted by a complex programmable logic device is received, analyze the waveform data to obtain real address information and task information, wherein the waveform data is waveform data that is converted, from data carried by a received task to be processed which is transmitted by a baseboard management controller, by the complex programmable logic device according to a set data conversion rule and is identifiable by the central processing unit; and
the feedback unit, configured to: in response to that the real address information is matched with an own address, feed response data corresponding to the task information back to the complex programmable logic device.

According to a seventh aspect, the embodiments of the present disclosure further provide a system for performance supervision, including a baseboard management controller, a central processing unit, and a complex programmable logic device respectively connected to the baseboard management controller and the central processing unit.

The baseboard management controller is configured to: transmit a task to be processed to the complex programmable logic device; receive effective data fed back by the complex programmable logic device; and extract desired data from the effective data;
the complex programmable logic device is configured to: receive the task to be processed which is transmitted by the baseboard management controller; convert, according to a set data conversion rule, data carried by the task to be processed into waveform data identifiable by the central processing unit; transmit the waveform data to the central processing unit; receive response data fed back by a target central processing unit, wherein the target central processing unit is a central processing unit matched with address information carried in the task to be processed; and convert the response data into effective data which meets a data transmission format requirement, and feed the effective data back to the baseboard management controller; and
the central processing unit is configured to: in response to that waveform data transmitted by the complex programmable logic device is received, analyze the waveform data to obtain real address information and task information; and in response to that the real address information is matched with an own address, feed the response data corresponding to the task information back to the complex programmable logic device.

In some embodiments of the present disclosure, the baseboard management controller is configured to: convert a control command to be sent into a command code; and convert the command code, the address information, and a command parameter into the task to be processed according to a data format corresponding to the command code.

In some embodiments of the present disclosure, the baseboard management controller extracts desired data from the effective data, which includes:
the baseboard management controller extracts data corresponding to an effective data field from the effective data according to the data format corresponding to the command code.

In some embodiments of the present disclosure, the baseboard management controller is connected to the complex programmable logic device through an I2C bus; and the complex programmable logic device is connected to the central processing unit through a general-purpose input/output interface.

According to an eighth aspect, the embodiments of the present disclosure further provide an electronic device, including:
a memory, configured to store a computer program; and
a processor, configured to run the computer program to implement the steps of the method for performance supervision as described above.

According to a ninth aspect, the embodiments of the present disclosure further provide a non-transitory computer-readable storage medium, having a computer program stored thereon. The computer program, when run by a processor, implements the steps of the method for performance supervision as described above.

### BRIEF DESCRIPTION OF THE DRAWINGS

For clearer descriptions of the embodiments of the present disclosure, the drawings required to be used in the embodiments are briefly introduced below. It is obvious that the drawings in the description below are only some embodiments of the present disclosure, and it is obvious for those skilled in the art that other drawings may be acquired according to the drawings without creative efforts.

FIG. 1 is a flowchart of a method for performance supervision provided according to some embodiments of the present disclosure;

FIG. 2 is a message format diagram showing that a BMC initiates a write command to a CPLD through an I2C bus provided according to some embodiments of the present disclosure;

FIG. 3 is a message format showing that a BMC initiates a read command to a CPLD through an I2C bus according to some embodiments of the present disclosure;

FIG. 4 is a block diagram of a system based on a platform environment control link of a CPLD provided according to some embodiments of the present disclosure;

FIG. 5 is a schematic structural diagram of an apparatus for performance supervision provided according to some embodiments of the present disclosure;

FIG. 6 is a schematic structural diagram of a system for performance supervision provided according to some embodiments of the present disclosure; and

FIG. 7 is a structural diagram of an electronic device provided according to some embodiments of the present disclosure.

### DETAILED DESCRIPTION OF THE EMBODIMENTS

The technical solutions in embodiments of the present disclosure are clearly and completely described in the following with reference to the accompanying drawings in the embodiments of the present disclosure. Apparently, the described embodiments are merely some rather than all of the embodiments of the present disclosure. All other embodiments obtained by a person of ordinary skill in the art based on the embodiments of the present disclosure without making creative efforts shall fall within the protection scope of the present disclosure.

The terms “include”, “has”, and any variant of “include” and “has” in the specification and claims of the present disclosure and in the accompanying drawings above are intended to cover a non-exclusive inclusion. For example, a process, method, system, product, or device that includes a series of steps or units is not limited to the listed steps or units, but may include steps or units that are not listed.

In the related art, a Management Engine (ME) in a Platform Controller Hub (PCH, South Bridge) is used to obtain a CPU temperature and acquire key register information, and then send these data to a Baseboard Management Controller (BMC) for further processing. Since the ME undertakes many complex tasks for managing the server, the obtaining of the CPU temperature and the acquisition of the register information are often interrupted by other tasks. Meanwhile, when the server has a system crash, the ME is also likely to be affected and unable to function. Therefore, the related art has low information acquisition efficiency, and may even have the problem of failure in obtaining the temperature and the register information, which seriously affects the overall server management and monitoring efficiency.

To solve the above technical problem, and to make a skilled person in the art better understand the solutions of the present disclosure, the present disclosure will be further explained in detail below in conjunction with the accompanying drawings and specific implementations.

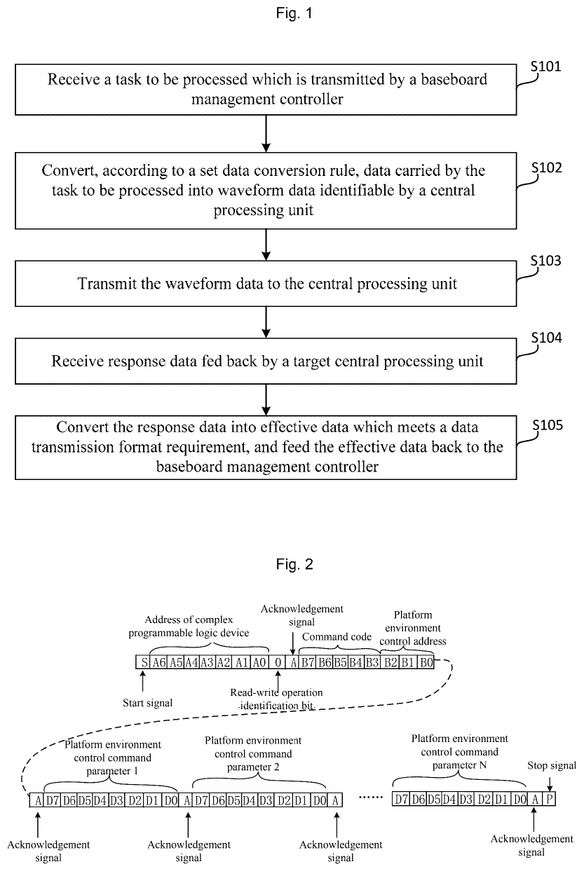

Next, a method for performance supervision provided according to the embodiments of the present disclosure will be introduced in detail. FIG. 1 is a flowchart of a method for performance supervision provided according to some embodiments of the present disclosure. The method includes:

S101: A task to be processed which is transmitted by a baseboard management controller is received.

The task to be processed may be diverse, including a connection establishment task, a read task, and a write task. Based on different management requirements, each task may further include different subtasks. For example, the read task may include reading a temperature of a central processing unit, reading register information, or the like.

In the embodiments of the present disclosure, the above operations may be performed by a Complex Programmable Logic Device (CPLD). The complex programmable logic device is a component that is originally included in a server system, which will not increase the hardware cost of server performance monitoring. The CPLD may interact with the BMC and the CPU separately. In practical applications, communication between the CPLD and the BMC may be carried out based on an I2C bus, and communication between the CPLD and the CPU may be carried out based on a General-Purpose Input/Output (GPIO) interface. CPLD may be replaced with any device for performing the above operations, for example, it may also include a Microcontroller Unit (MCU), etc.

The task to be processed which is transmitted by the BMC to the CPLD may include a task type, address information used for indicating a CPU needing to be accessed, and a command parameter required to execute the task. Common platform environment control commands may include a connection command (Ping), a bitmap obtaining command (GetDIB), and a file directory obtaining command (GetTemp).

Data for interaction between the BMC and the CPLD needs to comply with an I2C protocol, so when the BMC transmits the task to be processed to the CPLD, information used for representing the task type may be converted into a command code that meets a transmission requirement. Based on task types needing to be executed in practical applications, using five bits of data may fully cover all the task types. Therefore, in the embodiments of the present disclosure, the five bits of data may be used to record the command code.

Considering that in practical applications, the number of CPUs included in a server system generally does not exceed 8, three bits of data may be used to represent the address information of different CPUs. Of course, in practical applications, as the number of CPUs increases, more bits of data may be allocated to record the address information of the CPUs. Three bits are only an example and not a limitation on the length of the address information of the CPUs.

A byte contains eight bits. The command code occupying five bits and the address information occupying three bits are taken as an example. The command code and the address information may be written into the same byte. The command parameter is written into a subsequent byte adjacent to this byte, thus forming the task to be processed and transmitting the task to be processed to the CPLD.

S102: Data carried by the task to be processed is converted into waveform data identifiable by a central processing unit according to a set data conversion rule.

In practical applications, the CPLD and the BMC communicate with each other based on the I2C bus, and the CPLD and the CPU communicate with each other based on the GPIO interface.

Data transmission formats supported by the two kinds of communications are not the same. Therefore, after receiving the task to be processed which is transmitted by the BMC, the CPLD needs to extract the command type, the command parameter, and the address information from the task to be processed according to a set data format between the BMC and the CPLD.

Since the address information transmitted by the BMC is not in an address format identifiable by the CPU, the address information needs to be converted into real address information identifiable by the CPU according to a set address conversion rule.

In practical applications, the CPU address information involved is summarized to construct an address conversion list. Various pieces of I2C protocol address information and address information which respectively corresponds to the I2C protocol address information and is identifiable by the central processing unit are recorded in the address conversion list. In the embodiments of the present disclosure, the address information identifiable by the central processing unit may be referred to as the real address information.

Correspondingly, after obtaining the address information by analysis, the CPLD may inquire the real address information matched with the address information from the set address translation list.

Table 1 shows the address translation list. In Table 1, the serial numbers are used to distinguish different pieces of address information. The I2C protocol address means a platform environment control address in the I2C protocol, which is presented in a binary form. The real address is presented in a hexadecimal form.

TABLE 1

| | I2C protocol address | Real address |
|---|---|---|
| Serial number | (binary) | (Hexadecimal) |
| 1 | 000 | 0x30 |
| 2 | 001 | 0x31 |
| 3 | 010 | 0x32 |
| 4 | 011 | 0x33 |
| 5 | 100 | 0x34 |
| 6 | 101 | 0x35 |
| 7 | 110 | 0x36 |
| 8 | 111 | 0x37 |

The GPIO may be used for transmitting waveform data. Therefore, after the CPLD extracts the command type, the command parameter, and the address information from the task to be processed, and converts the address information into the real address information identifiable by the central processing unit, the CPLD may convert the command type, the command parameter, and the real address information into the waveform data.

The waveform data is an analog signal supported by a platform environment control bus of the central processing unit.

The number of the command type is limited, and each command type belongs to fixed information. To improve the waveform data conversion efficiency, waveforms corresponding to different command types may be pre-stored. For ease of distinguishing, the waveforms corresponding to the command types may be referred to as command waveforms, and the waveforms corresponding to specific data such as the command parameter and the address information may be referred to as information waveforms.

In specific implementation, the CPLD may inquire a target command waveform matched with the command type from pre-stored command waveforms; convert the command parameter and the real address information into information waveforms; and combine the target command waveform and the information waveforms into the waveform data.

S103: The waveform data is transmitted to a central processing unit.

The CPLD is provided with a GPIO interface, and the CPU may allocate a corresponding platform environment control port to achieve connection to the GPIO interface through the platform environment control bus. In practical applications, the server system includes a large number of CPUs, and the CPLD may transmit the waveform data to all the CPUs through the platform environment control bus.

S104: Response data fed back by a target central processing unit is received.

The target central processing unit is a central processing unit matched with address information carried in the task to be processed.

Each CPU may analyze the waveform data to obtain the command type, the command parameter, and the real address information. Each CPU may compare the real address information carried by the waveform data with its own address information. If the real address information carried by the waveform data is consistent with its own address information, the CPU feeds back the corresponding response data to the CPLD based on the command type and the command parameter. For example, if the command type is to read register information and the command parameter includes an identifier of a register, the CPU may rely on the identifier to determine a specific corresponding register, thereby reading the information recorded in the register and feeding back the read register information as the response data to the CPLD.

For example, in response to that the task to be processed is to read temperature information of the target central processing unit, the response data includes the temperature information of the target central processing unit; and in response to that the task to be processed is to read information of a target register in the target central processing unit, the response data includes the register information of the target register.

S105: The response data is converted into effective data which meets a data transmission format requirement, and the effective data is fed back to the baseboard management controller.

In practical applications, to ensure the accuracy of data transmission, the response data fed back by the CPU to the CPLD often carries check information.

After obtaining the response data, the CPLD may analyze the response data according to a data transmission format corresponding to the central processing unit to obtain check information and initial effective data; check the response data by using the check information; and in response to that the checking performed on the response data succeeds, and a read request transmitted by the baseboard management controller is received, convert the initial effective data into effective data matched with a data format corresponding to the read request. The check information may be Cyclic Redundancy Check (CRC) code.

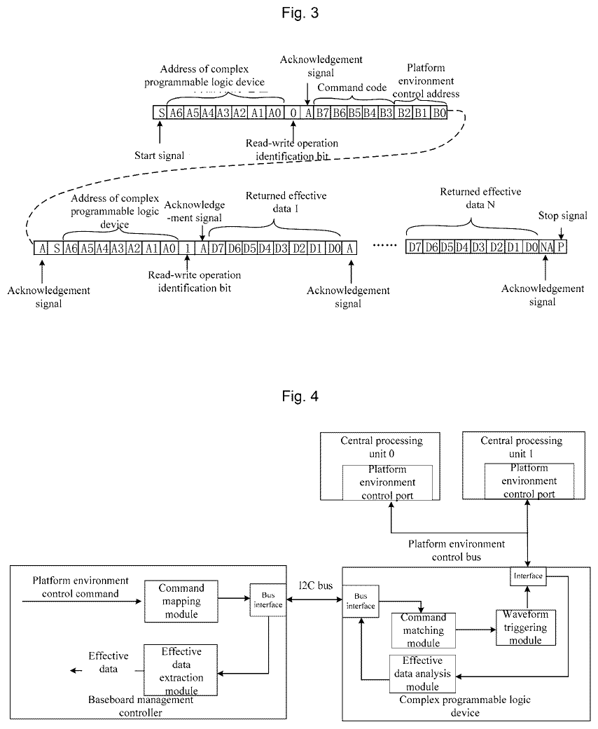

In the embodiments of the present disclosure, an I2C-based platform environment control transmission protocol may be set. The protocol is used for completing I2C-based platform environment control command interaction and data transmission and receiving functions between the BMC and the CPLD. Based on the transmission protocol, a message format of a write command initiated by the BMC to the CPLD through the I2C bus is as shown in FIG. 2, and a message format of a read command initiated by the BMC to the CPLD through the I2C bus is as shown in FIG. 3.

In FIG. 2, the slave address represents the address of the CPLD, and is a read-write operation identifier bit. When the value of the read-write operation identifier bit is 0, it indicates a write operation; and when the value of the read-write operation identifier bit is 1, it indicates a read operation. An acknowledgement signal (ACK) set between the bytes in FIG. 2 is a signal that needs to be filled in by the CPLD. Five bits from B7 to B3 in FIG. 2 may be used for recording command codes. Three bits from B2 to BO are used for recording a platform environment control address. The platform environment control address means an address that needs to be accessed by the CPU. Subsequent bytes may be filled in by platform environment control command parameters in sequence.

The BMC sending a read task to the CPLD is taken as an example. In practical applications, the CPLD may set a read-write operation identifier bit in a character string corresponding to the read request to a read identifier; and fill in free fields, adjacent to the read identifier, in the character string with the initial effective data in sequence to obtain the effective data.

In FIG. 3, the read command carries two slave addresses, both of which represent the address of the CPLD. R/W̅′=0 recorded behind the first slave address represents a BMC write command code and a platform environment control address. R/W̅=1 recorded behind the second slave address represents the effective data returned by the CPLD.

Based on the above introduction, it can be seen that in the embodiments of the present disclosure, through the interactions between the CPLD and the BMC, as well as between the CPLD and the CPU, the temperature data, the register information, and the like of the CPU may be promptly and quickly fed back to the BMC, facilitating the BMC to monitor the CPU.

According to the functions needing to be achieved by the BMC and the CPLD, a command mapping module and an effective data extraction module may be set in the BMC. A command matching module, a waveform triggering module, and an effective data analysis module are set in the CPLD. A platform environment control port may be provided on each CPU to achieve interaction with the CPLD through the platform environment control bus.

FIG. 4 is a block diagram of a system based on a platform environment control link of a CPLD provided according to an embodiment of the present disclosure. A BMC and the CPLD are connected through an I2C bus, and the CPLD and a CPU are connected through a platform environment control bus. In FIG. 4, two CPUs are taken as an example, namely CPU0 and CPU1. In practical applications, more CPUs may be included.

The BMC sending a connection task to the CPLD is taken as an example. The connection task sent by the BMC to the CPLD may use a Ping command. The BMC first converts the Ping command into a command code through the command mapping module. Command codes corresponding to different commands may be customized. Assuming that the command code corresponding to the Ping command is five bits of data: 5′b00001. It is worth noting that the command mapping module not only converts the Ping commands into the command code, but also completes a bit byte splicing function for the command code and a platform environment control address. It is assumed that the platform environment control address is three bits of data: 3′b000. The client addresses of CPU0 and CPU1 are 0x30 and 0x31, respectively. The command code in a spliced byte occupies the top five bits of the byte, and the platform environment control address occupies the bottom three bits of the byte. A splicing form may be seen in FIG. 2 and will not be elaborated here.

After the BMC generates the spliced byte of the command code and the platform environment control address, the BMC confirms the slave address of the CPLD, platform environment control command parameter 1, . . . , and platform environment control command parameter N. For the Ping command, platform environment control command parameters that need to be carried include two bytes: Write Length and Read Length. Next, data transmission is performed through an I2C channel between the BMC and the CPLD according to the message command format shown in FIG. 2.

After receiving the data sent by the BMC through the I2C channel, the CPLD extracts the command code and the platform environment control address through the command matching module, and then compares the command code and the platform environment control address with a local command list to identify that the BMC sends the Ping command. The local command list may be based on command types respectively corresponding to different command codes.

After identifying the Ping command, the CPLD first converts the platform environment control address into a real platform environment control address according to Table 1 described above. It is assumed that the converted address is 0x30. Next, the waveform triggering module is activated to generate a matching Ping command waveform, and send the matching Ping command waveform to the platform environment control bus through a GPIO pin.

The platform environment control ports of CPU0 and CPU1 monitors a state of the platform environment control bus. When “sensing” that there is request data on the bus, the CPUs first analyze the Ping command waveform to obtain the address 0x30. At this point, CPU0 and CPU1 are compared with their respective platform environment control addresses. CPU1 does not make a response if it finds a mismatch with its own address. If CPU0 finds a match with its own address, CPU0 sends the response data of the Ping command (the response data of the Ping command may be a byte-sized CRC information, defined as a Frame Check Sequence (FCS)) to the platform environment control bus.

The CPLD receives the response data of the CPUs from the platform environment control bus through the GPIO pin, and obtains the check information carried by the response data by analysis through the effective data analysis module. The effective data analysis module first needs to perform CRC on the response data; and if the check succeeds, extract the response data other than FCS data as the effective data after analysis.

It should be noted that the effective data analyzed by the CPLD still needs to be subjected to format conversion before being fed back to the BMC. For ease of distinguishing, the effective data before format conversion may be referred to as initial effective data.

In practical applications, to later inform the BMC of whether there is a client device with address 0x30 on the platform environment control bus, a byte of effective data may be replied.

In a case of receiving response information which is fed back by the CPUs and indicates that connection is successful, the CPLD may set a connection identification bit in a character string corresponding to the connection task to a successful connection identifier; and feed the character string with the successful connection identifier as the effective data back to the baseboard management controller.

For example, this function may be achieved using returned effective data 1 in FIG. 3. When the value of returned effective data 1 is 0x0, it indicates that the Ping command cannot achieve connection to a 0x30 device; and when the value of returned effective data 1 is 0x1, it indicates that the Ping command can achieve connection to a 0x30 device.

The BMC initiates a platform environment control command read operation to the CPLD through the I2C bus according to the message format in FIG. 3, and the CPLD will return effective data to the I2C bus. Then, the BMC receives the effective data returned by the CPLD through the I2C channel and extracts the effective data through the effective data extraction module. Finally, the BMC processes the extracted effective data. The Ping command is taken as an example. The BMC may process the extracted effective data by determining whether the effective data is 0x1. If yes, it indicates that there is a client device with address 0x30 on the platform environment control bus. If another platform environment control command (a command other than the Ping command) is sent, effective data returned by a corresponding number of bytes is extracted according to a control protocol specification for other processing.

For the operations mentioned above, the functional modules related to the BMC may be implemented by firmware of the BMC, and an implementation code is usually stored in an external flash storage medium of a BMC chip. The functional modules related to the CPLD may be implemented by firmware of the CPLD. The firmware of the CPLD is generally stored in a non-volatile storage medium inside the CPLD.

For the system based on the platform environment control link of the CPLD shown in FIG. 4, a reliable path from the BMC to the CPU may always be achieved under normal operations of the BMC and the CPLD. Compared with an ME path with numerous tasks and high possibility of failure, the system provided in the present disclosure greatly increases the success rate of CPU temperature obtaining and register acquisition, and solves the problems of low overall server management and control capability and efficiency caused by the obtaining of the CPU temperature and register information by an ME channel.

From the above technical solutions, it can be seen that a task to be processed which is transmitted by a baseboard management controller is received; data carried by the task to be processed is converted, according to a set data conversion rule, into waveform data identifiable by a central processing unit; the waveform data is transmitted to the central processing unit; response data fed back by a target central processing unit is received, wherein the target central processing unit is a central processing unit matched with address information carried in the task to be processed; and the response data is converted into effective data which meets a data transmission format requirement, and the effective data is fed back to the baseboard management controller. In this technical solution, the above operations may be performed by a complex programmable logic device. The complex programmable logic device is a component that is originally included in a server system, which will not increase the hardware cost of server performance monitoring. A platform environment control channel is constructed between the baseboard management controller and the central processing unit based on the complex programmable logic device. When the baseboard management controller needs to obtain relevant data from a or some central processing units, the baseboard management controller may directly send a task to be processed to the complex programmable logic device. The complex programmable logic device may interact with the central processing unit to obtain desired effective data and feed the effective data back to the baseboard management controller. This implementation process fully uses the high processing instantaneity of the complex programmable logic device to monitor and manage data on the central processing unit, thereby significantly improving the success rate of acquiring information of the central processing unit in the server system and solving the problem of low overall server management and control capability and efficiency caused by relying on an ME channel to obtain the information related to the central processing unit in the traditional method. Meanwhile, the controller design of the baseboard management controller special for a platform management and control function may be eliminated, which further reduces the chip cost.

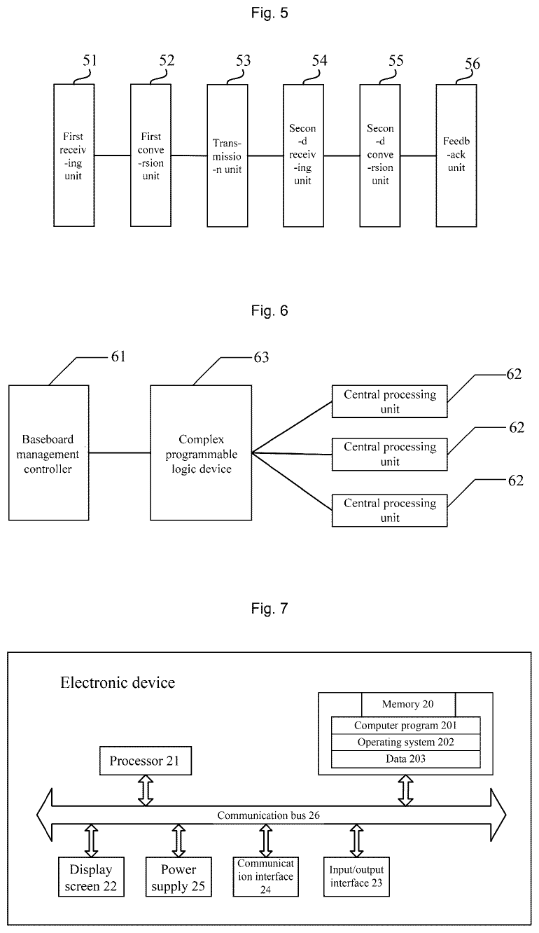

FIG. 5 is a schematic structural diagram of an apparatus for performance supervision provided according to an embodiment of the present disclosure, applicable to a complex programmable logic device. The apparatus includes a first receiving unit 51, a first conversion unit 52, a transmission unit 53, a second receiving unit 54, a second conversion unit 55, and a feedback unit 56;
the first receiving unit 51 is configured to receive a task to be processed which is transmitted by a baseboard management controller;
the first conversion unit 52 is configured to convert, according to a set data conversion rule, data carried by the task to be processed into waveform data identifiable by a central processing unit;
the transmission unit 53 is configured to transmit the waveform data to the central processing unit;
the second receiving unit 54 is configured to receive response data fed back by a target central processing unit, wherein the target central processing unit is a central processing unit matched with address information carried in the task to be processed;
the second conversion unit 55 is configured to convert the response data into effective data which meets a data transmission format requirement; and
the feedback unit 56 is configured to feed the effective data back to the baseboard management controller.

In some embodiments of the present disclosure, the first conversion unit includes an extraction subunit, an address conversion subunit, and a waveform conversion subunit;
the extraction subunit is configured to extract a command type, a command parameter, and the address information from the task to be processed according to a set data format;
the address conversion subunit is configured to convert, according to a set address conversion rule, the address information into real address information identifiable by the central processing unit; and
the waveform conversion subunit is configured to convert the command type, the command parameter, and the real address information into the waveform data.

In some embodiments of the present disclosure, the address conversion subunit is configured to inquire the real address information matched with the address information from a set address conversion list, wherein various pieces of I2C protocol address information and address information which respectively corresponds to the I2C protocol address information and is identifiable by the central processing unit are recorded in the address conversion list.

In some embodiments of the present disclosure, the waveform conversion subunit is configured to: inquire a target command waveform matched with the command type from pre-stored command waveforms; convert the command parameter and the real address information into information waveforms; and combine the target command waveform and the information waveforms into the waveform data.

In some embodiments of the present disclosure, the second conversion unit includes an analysis subunit, a check subunit, and a format conversion subunit;
the analysis subunit is configured to analyze the response data according to a data transmission format corresponding to the central processing unit to obtain check information and initial effective data;
the checking subunit is configured to check the response data by using the check information; and
the format conversion subunit is configured to: in response to that the checking performed on the response data succeeds, and a read request transmitted by the baseboard management controller is received, convert the initial effective data into effective data matched with a data format corresponding to the read request.

In some embodiments of the present disclosure, the format conversion subunit is configured to: set a read-write operation identifier bit in a character string corresponding to the read request to a read identifier; and fill in free fields, adjacent to the read identifier, in the character string with the initial effective data in sequence to obtain the effective data.

In some embodiments of the present disclosure, in response to that the task to be processed is a connection task, the second conversion unit is configured to: in response to that the response data is response information indicating that connection is successful, set a connection identification bit in a character string corresponding to the connection task to a successful connection identifier; and
the feedback unit is configured to feed the character string with the successful connection identifier as the effective data back to the baseboard management controller.

In some embodiments of the present disclosure, in response to that the task to be processed is to read temperature information of the target central processing unit, correspondingly, the response data includes the temperature information of the target central processing unit; and in response to that the task to be processed is to read information of a target register in the target central processing unit, correspondingly, the response data includes the register information of the target register.

The explanation of the features in the embodiment corresponding to FIG. 5 may be found in the related explanation of the embodiment corresponding to FIG. 1 and will not be elaborated here.

From the above technical solutions, it can be seen that a task to be processed which is transmitted by a baseboard management controller is received; data carried by the task to be processed is converted, according to a set data conversion rule, into waveform data identifiable by a central processing unit; the waveform data is transmitted to the central processing unit; response data fed back by a target central processing unit is received, wherein the target central processing unit is a central processing unit matched with address information carried in the task to be processed; and the response data is converted into effective data which meets a data transmission format requirement, and the effective data is fed back to the baseboard management controller. In this technical solution, the above operations may be performed by a complex programmable logic device. The complex programmable logic device is a component that is originally included in a server system, which will not increase the hardware cost of server performance monitoring. A platform environment control channel is constructed between the baseboard management controller and the central processing unit based on the complex programmable logic device. When the baseboard management controller needs to obtain relevant data from a or some central processing units, the baseboard management controller may directly send a task to be processed to the complex programmable logic device. The complex programmable logic device may interact with the central processing unit to obtain desired effective data and feed the effective data back to the baseboard management controller. This implementation process fully uses the high processing instantaneity of the complex programmable logic device to monitor and manage data on the central processing unit, thereby significantly improving the success rate of acquiring information of the central processing unit in the server system and solving the problem of low overall server management and control capability and efficiency caused by relying on an ME channel to obtain the information related to the central processing unit in the traditional method. Meanwhile, the controller design of the baseboard management controller special for a platform management and control function may be eliminated, which further reduces the chip cost.

The embodiments of the present disclosure further provide a method for performance supervision, applicable to a baseboard management controller. The method includes:

A task to be processed is transmitted to a complex programmable logic device;
effective data fed back by the complex programmable logic device is received, wherein the effective data is effective data that is converted, after data carried by the task to be processed is converted into waveform data identifiable by a central processing unit according to a set data conversion rule by the complex programmable logic device, from response data fed back by the central processing unit and meets a data transmission format requirement; and
desired data is extracted from the effective data.

In some embodiments of the present disclosure, a task to be processed is transmitted to a complex programmable logic device, which includes:

A control command to be sent is converted into a command code; and
the command code, address information, and a command parameter are converted into the task to be processed according to a data format corresponding to the command code.

The embodiments of the present disclosure further provide an apparatus for performance supervision, applicable to a baseboard management controller. The apparatus includes a transmission unit, a receiving unit, and an extraction unit;
the transmission unit is configured to transmit a task to be processed to a complex programmable logic device;
the receiving unit is configured to receive effective data fed back by the complex programmable logic device, wherein the effective data is effective data that is converted, after data carried by the task to be processed is converted into waveform data identifiable by a central processing unit according to a set data conversion rule by the complex programmable logic device, from response data fed back by the central processing unit and meets a data transmission format requirement; and
the extraction unit is configured to extract desired data from the effective data.

The embodiments of the present disclosure further provide a method for performance supervision, applicable to a central processing unit. The method includes:
in response to that waveform data transmitted by a complex programmable logic device is received, analyzing the waveform data to obtain real address information and task information, wherein the waveform data is waveform data that is converted, from data carried by a received task to be processed which is transmitted by a baseboard management controller, by the complex programmable logic device according to a set data conversion rule and is identifiable by the central processing unit; and
in response to that the real address information is matched with an own address, feeding response data corresponding to the task information back to the complex programmable logic device.

The embodiments of the present disclosure further provide an apparatus for performance supervision, applicable to a central processing unit. The apparatus includes an analysis unit and a feedback unit;
the analysis unit is configured to: in response to that waveform data transmitted by a complex programmable logic device is received, analyze the waveform data to obtain real address information and task information, wherein the waveform data is waveform data that is converted, from data carried by a received task to be processed which is transmitted by a baseboard management controller, by the complex programmable logic device according to a set data conversion rule and is identifiable by the central processing unit; and
the feedback unit, configured to: in response to that the real address information is matched with an own address, feed response data corresponding to the task information back to the complex programmable logic device.

FIG. 6 is a schematic structural diagram of a system for performance supervision provided according to an embodiment of the present disclosure. The system for performance supervision includes a baseboard management controller 61, a central processing unit 62, and a complex programmable logic device 63 respectively connected to the baseboard management controller 61 and the central processing unit 62. There may be a plurality of central processing units 62. In FIG. 6, three central processing units are taken as an example. In practical applications, there may be more or less central processing units 62.

The baseboard management controller 61 is configured to: transmit a task to be processed to the complex programmable logic device 63; receive effective data fed back by the complex programmable logic device 63; and extract desired data from the effective data;
the complex programmable logic device 63 is configured to: receive the task to be processed which is transmitted by the baseboard management controller 61; convert, according to a set data conversion rule, data carried by the task to be processed into waveform data identifiable by the central processing units 62; transmit the waveform data to the central processing units 62; receive response data fed back by a target central processing unit 62, wherein the target central processing unit 62 is a central processing unit 62 matched with address information carried in the task to be processed; and convert the response data into effective data which meets a data transmission format requirement, and feed the effective data back to the baseboard management controller 61; and
the central processing units 62 are configured to: in response to that waveform data transmitted by the complex programmable logic device 63 is received, analyze the waveform data to obtain real address information and task information; and in response to that the real address information is matched with an own address, feed the response data corresponding to the task information back to the complex programmable logic device 63.

In some embodiments of the present disclosure, the baseboard management controller is configured to: convert a control command to be sent into a command code; and convert the command code, the address information, and a command parameter into the task to be processed according to a data format corresponding to the command code.

In some embodiments of the present disclosure, the baseboard management controller extracts desired data from the effective data, which includes:
the baseboard management controller extracts data corresponding to an effective data field from the effective data according to the data format corresponding to the command code.

In some embodiments of the present disclosure, the baseboard management controller is connected to the complex programmable logic device through an I2C bus; and the complex programmable logic device is connected to the central processing unit through a general-purpose input/output interface.

The explanation of the features in the embodiment corresponding to FIG. 6 may be found in the related explanation of the embodiment corresponding to FIG. 1 and will not be elaborated here.

From the above technical solutions, it can be seen that a task to be processed which is transmitted by a baseboard management controller is received; data carried by the task to be processed is converted, according to a set data conversion rule, into waveform data identifiable by a central processing unit; the waveform data is transmitted to the central processing unit; response data fed back by a target central processing unit is received, wherein the target central processing unit is a central processing unit matched with address information carried in the task to be processed; and the response data is converted into effective data which meets a data transmission format requirement, and the effective data is fed back to the baseboard management controller. In this technical solution, the above operations may be performed by a complex programmable logic device. The complex programmable logic device is a component that is originally included in a server system, which will not increase the hardware cost of server performance monitoring. A platform environment control channel is constructed between the baseboard management controller and the central processing unit based on the complex programmable logic device. When the baseboard management controller needs to obtain relevant data from a or some central processing units, the baseboard management controller may directly send a task to be processed to the complex programmable logic device. The complex programmable logic device may interact with the central processing unit to obtain desired effective data and feed the effective data back to the baseboard management controller. This implementation process fully uses the high processing instantaneity of the complex programmable logic device to monitor and manage data on the central processing unit, thereby significantly improving the success rate of acquiring information of the central processing unit in the server system and solving the problem of low overall server management and control capability and efficiency caused by relying on an ME channel to obtain the information related to the central processing unit in the traditional method. Meanwhile, the controller design of the baseboard management controller special for a platform management and control function may be eliminated, which further reduces the chip cost.

FIG. 7 is a schematic structural diagram of an electronic device provided according to an embodiment of the present disclosure. As shown in FIG. 7, the electronic device includes: a memory 20, configured to store a computer program; and
a processor 21, configured to run the computer program to implement the steps of the method for performance supervision of the above embodiment.

The electronic device provided in the embodiments of the present disclosure may include but is not limited to a smart phone, a tablet, a laptop, a desktop computer, or the like.

The processor 21 may include one or more processing cores, such as a 4-core processor and an 8-core processor. The processor 21 may be implemented in at least one hardware form, including Digital Signal Processing (DSP), a Field-Programmable Gate Array (FPGA), and a Programmable Logic Array (PLA). The processors 21 may also include a main processor and a coprocessor. The main processor is a processor configured for processing data in an awake state is also referred to as a Central Processing Unit (CPU). The coprocessor is a low-power processor configured for processing data in a standby state. In some embodiments, the processors 21 may be integrated with a Graphics Processing Unit (GPU). The GPU is configured for rendering and drawing content that needs to be displayed on a display screen. In some embodiments, the processors 21 may further include an Artificial Intelligence (AI) processor. The AI processor is configured for processing computing operations related to machine learning.

The memory 20 may include one or more non-volatile computer-readable storage media. The non-volatile computer-readable storage medium may be non-transitory. The memory 20 may also include high-speed random access memory and a non-volatile memory, such as one or more magnetic storage devices and flash storage devices. In the embodiments of the present disclosure, the memory 20 is at least configured to store a following computer program 201. After being loaded and run by the processor 21, the computer program may implement the relevant steps in the method for performance supervision disclosed in any one of the aforementioned embodiments. In addition, resources stored in the memory 20 may also include an operating system 202 and data 203, and a storage mode may be temporary storage or permanent storage. The operating system 202 may include Windows, Unix, Linux, and the like. The data 203 may include but is not limited to a data conversion rule, a data transmission format requirement, and the like.

In some embodiments, the electronic device may further include a display screen 22, an input/output interface 23, a communication interface 24, a power supply 25, and a communication bus 26.

A skilled person in the art may understand that the structures shown in FIG. 7 impose no limitation on the electronic device, and may include more or fewer components than those shown in the figure.

It should be understood that if the method for performance supervision in the above embodiments are implemented in a form of a software functional unit and sold or used as a stand-alone product, the text error correction method may be stored in a computer-readable storage medium. Based on this understanding, the technical solutions of the present disclosure essentially, or the part that contributes to the related art, or all or some of the technical solutions, may be reflected in the form of a software product. The computer software product is stored in a storage medium to execute all or some of the steps of the methods in the various embodiments of the present disclosure. The aforementioned storage medium includes: a USB flash disk, a portable hard disk drive, a Read-Only Memory (ROM), a Random Access Memory (RAM), an electrically erasable programmable ROM, a register, a hard disk drive, a removable magnetic disk, a Compact disc ROM (CD-ROM), a magnetic tape or an optical disc, and other media that can store program codes.

Based on this, the embodiments of the present disclosure further provide a non-transitory computer-readable storage medium, having a computer program stored thereon. The computer program, when run by a processor, implements the steps of the method for performance supervision described above.

The method for performance supervision, apparatus, and system, the device, and the non-transitory computer-readable storage medium provided by the embodiments of the present disclosure have been introduced in detail above. The various embodiments in this specification are described in a progressive manner, and each embodiment focuses on differences from other embodiments. The same and similar parts between all the embodiments may be referred to each other. Since the apparatus disclosed in the embodiments correspond to the method disclosed in the embodiments, the apparatus is described simply, and related parts are found in some of the explanations of the method.

A skilled person in the art may further realize that units and algorithm steps of all the examples described in the foregoing embodiments disclosed herein may be implemented by electronic hardware, computer software, or a combination thereof. To clearly describe the interchangeability between the hardware and the software, the foregoing has generally described compositions and steps of each example based on functions. Whether these functions are implemented as hardware or software depends on particular application and design constraint conditions of the technical solutions. A skilled person in the art may use different methods to implement the described functions for each particular application, but it should not be considered that the implementation goes beyond the scope of the present disclosure.

The method for performance supervision, apparatus, and system, the device, and the non-transitory computer-readable storage medium provided by the present disclosure have been introduced in detail above. The principles and implementations of the present disclosure are explained herein with specific examples, and the explanations of the above embodiments are only used to help understand the method of the present disclosure and a core idea of the method. It should be pointed out that a person of ordinary skill in the art may also make several improvements and modifications to the present disclosure without departing from the principles of the present disclosure, and these improvements and modifications also fall within the scope of protection of the claims of the present disclosure.

1. A method for performance supervision, comprising:
receiving a task to be processed which is transmitted by a baseboard management controller;
converting, according to a set data conversion rule, data carried by the task to be processed into waveform data identifiable by a central processing unit;
transmitting the waveform data to the central processing unit;
receiving response data fed back by a target central processing unit, wherein the target central processing unit is a central processing unit matched with address information carried in the task to be processed; and
converting the response data into effective data which meets a data transmission format requirement, and feeding the effective data back to the baseboard management controller.

2. The method for performance supervision as claimed in claim 1, wherein the converting, according to the set data conversion rule, data carried by the task to be processed into waveform data identifiable by the central processing unit comprises:
extracting a command type, a command parameter, and the address information from the task to be processed according to a set data format;
converting, according to a set address conversion rule, the address information into real address information identifiable by the central processing unit; and
converting the command type, the command parameter, and the real address information into the waveform data.

3. The method for performance supervision as claimed in claim 2, wherein the converting, according to the set address conversion rule, the address information into real address information identifiable by the central processing unit comprises:
inquiring the real address information matched with the address information from a set address conversion list, wherein various pieces of I2C protocol address information and address information which respectively corresponds to the I2C protocol address information and is identifiable by the central processing unit are recorded in the address conversion list.

4. The method for performance supervision as claimed in claim 2, wherein the converting the command type, the command parameter, and the real address information into the waveform data comprises:
inquiring a target command waveform matched with the command type from pre-stored command waveforms;
converting the command parameter and the real address information into information waveforms; and
combining the target command waveform and the information waveforms into the waveform data.

5. The method for performance supervision as claimed in claim 2, wherein the converting the response data into effective data which meets the data transmission format requirement comprises:
analyzing the response data according to a data transmission format corresponding to the central processing unit to obtain check information and initial effective data;
checking the response data by using the check information; and
in response to that the checking performed on the response data succeeds, and a read request transmitted by the baseboard management controller is received, converting the initial effective data into effective data matched with a data format corresponding to the read request.

6. The method for performance supervision as claimed in claim 5, wherein the converting the initial effective data into effective data matched with the data format corresponding to the read request comprises:
setting a read-write operation identifier bit in a character string corresponding to the read request to a read identifier; and
filling free fields, adjacent to the read identifier, in the character string with the initial effective data in sequence to obtain the effective data.

7. The method for performance supervision as claimed in claim 1, wherein in response to that the task to be processed is the connection task, the converting the response data into effective data which meets the data transmission format requirement, and feeding the effective data back to the baseboard management controller comprises:
in response to that the response data is response information indicating that connection is successful, setting a connection identification bit in a character string corresponding to the connection task to a successful connection identifier; and
feeding the character string with the successful connection identifier as the effective data back to the baseboard management controller.

8. The method for performance supervision as claimed in claim 1, wherein in response to that the task to be processed is to read temperature information of the target central processing unit, correspondingly, the response data comprises the temperature information of the target central processing unit; and in response to that the task to be processed is to read information of a target register in the target central processing unit, correspondingly, the response data comprises register information of the target register.

9. (canceled)

10. A method for performance supervision, applicable to a baseboard management controller, wherein the method comprises:
transmitting a task to be processed to a complex programmable logic device;
receiving effective data fed back by the complex programmable logic device, wherein the effective data is effective data that is converted, after data carried by the task to be processed is converted into waveform data identifiable by a central processing unit according to a set data conversion rule by the complex programmable logic device, from response data fed back by the central processing unit and meets a data transmission format requirement; and
extracting desired data from the effective data.

11. The method for performance supervision as claimed in claim 10, wherein the transmitting the task to be processed to the complex programmable logic device comprises:
converting a control command to be sent into a command code; and
converting the command code, address information, and a command parameter into the task to be processed according to a data format corresponding to the command code.

12. (canceled)

13. The method for performance supervision as claimed in claim 1,
in response to that waveform data transmitted by a complex programmable logic device is received, the central processing unit analyzes the waveform data to obtain real address information and task information, wherein the waveform data is waveform data that is converted, from data carried by a received task to be processed which is transmitted by a baseboard management controller, by the complex programmable logic device according to a set data conversion rule and is identifiable by the central processing unit; and
in response to that the real address information is matched with an own address, the central processing unit feeds response data corresponding to the task information back to the complex programmable logic device.

14. A system for performance supervision, comprising a baseboard management controller, a central processing unit, and a complex programmable logic device respectively connected to the baseboard management controller and the central processing unit, wherein
the baseboard management controller is configured to: transmit a task to be processed to the complex programmable logic device; receive effective data fed back by the complex programmable logic device; and extract desired data from the effective data;
the complex programmable logic device is configured to: receive the task to be processed which is transmitted by the baseboard management controller; convert, according to a set data conversion rule, data carried by the task to be processed into waveform data identifiable by the central processing unit; transmit the waveform data to the central processing unit; receive response data fed back by a target central processing unit, wherein the target central processing unit is a central processing unit matched with address information carried in the task to be processed; and convert the response data into effective data which meets a data transmission format requirement, and feed the effective data back to the baseboard management controller; and
the central processing unit is configured to: in response to that waveform data transmitted by the complex programmable logic device is received, analyze the waveform data to obtain real address information and task information; and in response to that the real address information is matched with an own address, feed the response data corresponding to the task information back to the complex programmable logic device.

15. The system for performance supervision as claimed in claim 14, wherein the baseboard management controller is configured to: convert a control command to be sent into a command code; and convert the command code, the address information, and a command parameter into the task to be processed according to a data format corresponding to the command code.

16. The system for performance supervision as claimed in claim 15, wherein the baseboard management controller extracts desired data from the effective data, which comprises:
the baseboard management controller extracts data corresponding to an effective data field from the effective data according to the data format corresponding to the command code.

17. The system for performance supervision as claimed in claim 14, wherein the baseboard management controller is connected to the complex programmable logic device through an I2C bus; and the complex programmable logic device is connected to the central processing unit through a general-purpose input/output interface.

18. The system for performance supervision as claimed in claim 14, wherein the complex programmable logic device is configured to: extract a command type, a command parameter, and the address information from the task to be processed according to the set data format; convert, according to a set address conversion rule, the address information into real address information identifiable by the central processing unit; and convert the command type, the command parameter, and the real address information into the waveform data.

19-20. (canceled)

21. The method for performance supervision as claimed in claim 1, wherein the waveform data is an analog signal supported by a platform environment control bus of the central processing unit.

22. The method for performance supervision as claimed in claim 6, wherein when a value of the read-write operation identifier bit is 0, it indicates a write operation; and when the value of the read-write operation identifier bit is 1, it indicates a read operation.

23. The method for performance supervision as claimed in claim 11, the method further comprising:
writing the command code and the address information into the same byte;
writing the command parameter into a subsequent byte adjacent to the same byte to form the task to be processed.

24. The system for performance supervision as claimed in claim 14, wherein the complex programmable logic device is configured to: inquire the real address information matched with the address information from a set address conversion list, wherein various pieces of I2C protocol address information and address information which respectively corresponds to the I2C protocol address information and is identifiable by the central processing unit are recorded in the address conversion list.
